(19) United States
(12) Patent Application Publication
(10) Pub. No.: US 2024/0205866 A1
(43) Pub. Date: Jun. 20, 2024

(54) METHOD, APPARATUS AND COMPUTER PROGRAM PRODUCT FOR PROVIDING RELAY FUNCTIONALITY IN A WIRELESS COMMUNICATION NETWORK

(71) Applicant: Telefonaktiebolaget LM Ericsson (publ), Stockholm (SE)

(72) Inventors: Zhang FU, Stockholm (SE); Juying GAN, Shanghai (CN); Shabnam SULTANA, Montreal (CA)

(21) Appl. No.: 18/286,983

(22) PCT Filed: Apr. 13, 2022
(86) PCT No.: PCT/CN2022/086648

§ 371 Date: Oct. 13, 2023

(30) Foreign Application Priority Data
Apr. 15, 2021 (WO) PCT/CN2021/087533

(51) Int. Cl. H04W 60/04; H04W 8/00; H04W 8/22; H04W 92/18

(52) U.S. Cl. CPC H04W 60/04; H04W 8/005; H04W 8/22; H04W 92/18

(57) ABSTRACT

The present disclosure generally relates to wireless or mobile communication. More particularly, the present disclosure relates to a method for providing relay functionality in a wireless communication network. The present disclosure also relates to apparatus and computer program product adapted for the same purpose. According to one embodiment, it provides a method for providing relay functionality in a wireless communication network, including the following steps carried out at a first network node: a) obtaining subscription data associated with a wireless communication device from a second network node and capability for U2N relay and/or U2U relay of the wireless communication device; b) based on the subscription data and the capability, generating authorization information specifying which role(s) the wireless communication device is authorized to act as in U2N relay and/or U2U relay; and c) sending the authorization information to a third network node.

### TECHNICAL FIELD

The present disclosure generally relates to wireless or mobile communication. More particularly, the present disclosure relates to a method for providing relay functionality in a wireless communication network. The present disclosure also relates to apparatus and computer program product adapted for the same purpose.

### BACKGROUND

### Layer 2 (L2) UE-to-Network (U2N) Relay

Layer-2 based UE-to-Network relay is described in 3GPP TR 23.752, which is incorporated by reference in its entirety.

A protocol architecture for supporting Layer-2 (L2) based UE-to-Network (U2N) relay is provided. The L2 UE-to-Network Relay UE provides forwarding functionality that can relay any type of traffic over PC5 link. The L2 UE-to-Network Relay UE also provides functionality to support connectivity to 5GS for Remote UEs. A UE is considered to be a Remote UE if it has successfully established a PC5 link to the L2 UE-to-Network Relay UE. A Remote UE can be located within NG-RAN coverage or outside of NG-RAN coverage.

FIG. 1 illustrates a protocol stack for user plane transport, related to a PDU Session, including a Layer 2 UE-to-Network Relay UE. The PDU layer corresponds to the PDU carried between the Remote UE and the Data Network (DN) over the PDU session. The PDU layer corresponds to the PDU carried between the Remote UE and the Data Network (DN) over the PDU session. It is important to note that the two endpoints of the PDCP link are the Remote UE and the gNB. The relay function is performed below PDCP. This means that data security is ensured between the Remote UE and the gNB without exposing raw data at the UE-to-Network Relay UE.

The adaptation rely layer within the UE-to-Network Relay UE can differentiate between signaling radio bearers (SRBs) and data radio bearers (DRBs) for a particular Remote UE. The adaption relay layer is also responsible for mapping PC5 traffic to one or more DRBs of the Uu. The definition of the adaptation relay layer is under the responsibility of RAN WG2.

FIG. 2 illustrates a protocol stack of NAS connection for a Remote UE to NAS-MM and NAS-SM components. NAS messages are transparently transferred between the Remote UE and 5G-AN over the Layer 2 UE-to-Network Relay UE using:
PDCP end-to-end connection where the role of the UE-to-Network Relay UE is to relay the PDUs over the signaling radio bear without any modifications.
N2 connection between the 5G-AN and AMF over N2.
N3 connection AMF and SMF over N11.

The role of the UE-to-Network Relay UE is to relay the PDUs from the signaling radio bearer without any modifications.

### Layer 3 (L3) UE-to-Network (U2N) Relay

Layer-3 based UE-to-Network relay is also described in 3GPP TR 23.752.

The ProSe 5G UE-to-Network Relay entity provides functionality to support connectivity to the network for Remote UEs, as shown in FIG. 3. It can be used for both public safety services and commercial services (e.g. interactive service).

A UE is considered to be a Remote UE for a certain ProSe UE-to-Network relay if it has successfully established a PC5 link to this ProSe 5G UE-to-Network Relay. A Remote UE can be located within NG-RAN coverage or outside of NG-RAN coverage.

The ProSe 5G UE-to-Network Relay shall relay unicast traffic (UL and DL) between the Remote UE and the network. The ProSe UE-to-Network Relay shall provide generic function that can relay any IP traffic.

One-to-one Direct Communication is used between Remote UEs and ProSe 5G UE-to-Network Relays for unicast traffic as specified in solutions for Key Issue #2 in 3GPP TR 23.752.

The protocol stack for Layer-3 UE-to-Network Relays is shown in FIG. 4.

Hop-by-hop security is supported in the PC5 link and Uu link. If there are requirements beyond hop-by-hop security for protection of Remote UE's traffic, security over IP layer needs to be applied.

The detailed description on the interception of the ProSe 5G UE-to-Network Relay may be found in the documents as cited follows, which are incorporated herein by reference in its entirety:
1. TS 23.501 V16.7.0
2. TS 23.502 V17.0.0
3. TS 23.503 V 17.0.0
4. TS 29.525 v17.2.0
5. TR 23.752 v17.0.0
6. TS 23.304 v0.1.0

### SUMMARY

It is desirable to support coexistence of Layer-2 Relay and Layer-3 Relay, including QoS and service continuity aspects, in 5GS. However, in order to support both Layer-3 and Layer-2 based UE-to-Network Relay, it is required to provide solutions for selecting type or role of relay, e.g., L2 relay or L3 relay, remote UE or relay UE.

The present disclosure discloses solutions for making the Layer-3 and Layer-2 based UE-to-Network Relay co-exist.

In one exemplary embodiment, UE provides its UE-to-Network Relay capability (i.e. Layer-2, or Layer-3 or both, remote UE, or relay UE or both) to a wireless communication network (Core Network (CN)/Radio Access Network (RAN)).

In another exemplary embodiment, subscription data in UDM is configured to include information concerning authorization, e.g., what type(s) of UE-to-Network Relay and/or UE-to-UE Relay (i.e. Layer-2, or Layer-3 or both, remote UE, or relay UE or both) can be used for UE(s).

In another exemplary embodiment, AMF generates authorization information, e.g., what type(s) of UE-to-Network Relay and/or UE-to-UE Relay (i.e. Layer-2, or Layer-3 or both, remote UE, or relay UE or both) are allowable to be used by the UE(s), based on the UE capability and subscription data and sends the authorization information to PCF.

In another exemplary embodiment, PCF provisions UE ProSe policy for UE-to-Network Relay and/or UE-to-UE Relay based on the authorization information provided by the AMF.

In another exemplary embodiment, AMF provides the authorization information, e.g., what role(s) or type(s) of UE-to-Network Relay and/or UE-to-UE Relay (i.e. Layer-2, or Layer-3 or both, remote UE, or relay UE or both) are allowable to be used, to UE(s). The UE(s) acts or operates as the role(s) as specified by the authorization information when performing discovery and/or communication.

In another exemplary embodiment, AMF provides the authorization information, e.g., what role(s) or type(s) of UE-to-Network Relay and/or UE-to-UE Relay (i.e. Layer-2, or Layer-3 or both, remote UE, or relay UE or both) are allowable to be used, to RAN.

It shall be noted that the solutions as described above and below are applicable to both UE-to-Network relay use case and UE-to-UE Network relay use case.

### BRIEF DESCRIPTION OF THE DRAWINGS

The foregoing and other objects, features, and advantages of the disclosure would be apparent from the following more particular description of preferred embodiments as illustrated in the accompanying drawings in which:

FIG. 1 illustrates an example of a User Plane Stack for L2 UE-to-Network Relay.

FIG. 2 illustrates an example of Control Plane for L2 UE-to-Network Relay.

FIG. 3 illustrates an example of an architecture model using a ProSe 5G UE-to-Network Relay.

FIG. 4 illustrates an example of a protocol stack for ProSe 5G UE-to-Network Relay.

FIG. 5 is a flowchart illustrating a method for providing relay functionality implemented in a wireless communication network, in accordance with one embodiment.

FIG. 6 is a flowchart illustrating a method for providing relay functionality implemented in a wireless communication network, in accordance with another embodiment.

FIG. 7 is a flowchart illustrating a method for providing relay functionality implemented in a wireless communication network, in accordance with another embodiment.

FIG. 8 is a flowchart illustrating a method for providing relay functionality implemented in a wireless communication network, in accordance with another embodiment.

FIG. 9 is a flowchart illustrating a method for providing relay functionality implemented in a wireless communication network, in accordance with another embodiment.

FIG. 10 illustrates a processor-based implementation of a network node which may be used for implementing the above-described embodiments.

FIG. 11 illustrates a processor-based implementation of a wireless communication device which may be used for implementing the above-described embodiments.

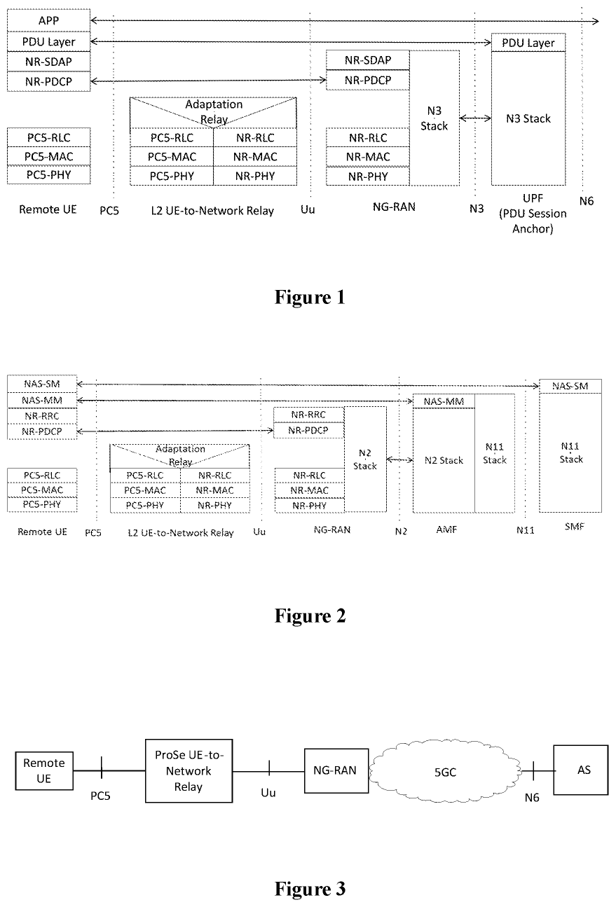

### DETAILED DESCRIPTION

Before describing in detail exemplary embodiments, it is noted that components have been represented where appropriate by conventional symbols in the drawings, showing only those specific details that are pertinent to understanding the embodiments so as not to obscure the disclosure with details that will be readily apparent to those of ordinary skill in the art having the benefit of the description. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In some embodiments described herein, the term “coupled,” “connected,” and the like, may be used herein to indicate a connection, although not necessarily directly, and may include wired and/or wireless connections.

The term “wireless communication device” herein can be any type of device capable of communicating with a network node or another communication device over radio signals. The wireless communication device might be a radio communication device, target device, a user equipment (UE), a device to device (D2D) wireless device, machine type wireless device or wireless device capable of machine to machine communication (M2M), low-cost and/or low-complexity wireless device, a sensor equipped with wireless device, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc. The communication device might be a vehicle capable of supporting V2X communications.

FIG. 5 is a flowchart illustrating a method for providing relay functionality implemented in a wireless communication network, in accordance with one embodiment. The wireless communication network may include a Radio Access Network (RAN) and a Core Network (CN) including a plurality of network nodes, e.g., AMF node, UDM node, PCF node, NEF node, NRF node, SMF node, AUSP node and AF node.

At step 510, during a registration procedure, a UE sends a report to a wireless communication network. In the present embodiment, the report describes the UE's capability for UE-to-Network (U2N) relay and/or UE-to-UE (U2U) relay. Optionally, the report may indicate at least one of the following items:
whether the UE is capable of acting as a remote UE for Layer-2 U2N relay;
whether the UE is capable of acting as a relay UE for Layer-2 U2N relay;
whether the UE is capable of acting as a remote UE for Layer-3 U2N relay;
whether the UE is capable of acting as a relay UE for Layer-3 U2N relay;
whether the UE is capable of acting as a remote UE for Layer-2 U2U relay;
whether the UE is capable of acting as a relay UE for Layer-2 U2U relay;
whether the UE is capable of acting as a remote UE for Layer-3 U2U relay; and
whether the UE is capable of acting as a relay UE for Layer-3 U2U relay.

From the report, the network, e.g., AMF node, has the knowledge on which type or role of relay the UE can act as.

FIG. 6 is a flowchart illustrating a method for providing relay functionality implemented in a wireless communication network, in accordance with another embodiment. The wireless communication network may include a Radio Access Network (RAN) and a Core Network (CN) including a plurality of network nodes, e.g., AMF node, UDM node, PCF node, NEF node, NRF node, SMF node, AUSP node and AF node.

At step 610, a UE receives authorization information from a wireless communication network. In this embodiment, the authorization information is configured to specify which role(s) the UE is authorized or allowed to act or operate as in U2N relay and/or U2U relay.

Optionally, the authorization information may be configured to specify at least one of the following items:
whether the UE is authorized to act as a remote UE for Layer-2 U2N relay;
whether the UE is authorized to act as a relay UE for Layer-2 U2N relay;
whether the UE is authorized to act as a remote UE for Layer-3 U2N relay;
whether the UE is authorized to act as a relay UE for Layer-3 U2N relay;
whether the UE is authorized to act as a remote UE for Layer-2 U2U relay;
whether the UE is authorized to act as a relay UE for Layer-2 U2U relay;
whether the UE is authorized to act as a remote UE for Layer-3 U2U relay; and
whether the UE is authorized to act as a relay UE for Layer-3 U2U relay.

At step 620, the UE acts as the role(s) as specified by the authorization information when performing discovery and/or a communication. For example, if it specifies that the UE is authorized to act as a remote UE for Layer-2 U2N relay in the authorization information, the UE can only act as a remote UE in Layer-2 U2N relay. In other words, the other roles, e.g., remote UE for Layer-3 U2N relay, Layer-2 U2U relay, Layer-3 U2U relay, and relay UE for Layer-2 U2N relay, Layer-3 U2N relay, Layer-2 U2U relay and Layer-3 U2U relay, are unallowable for the UE.

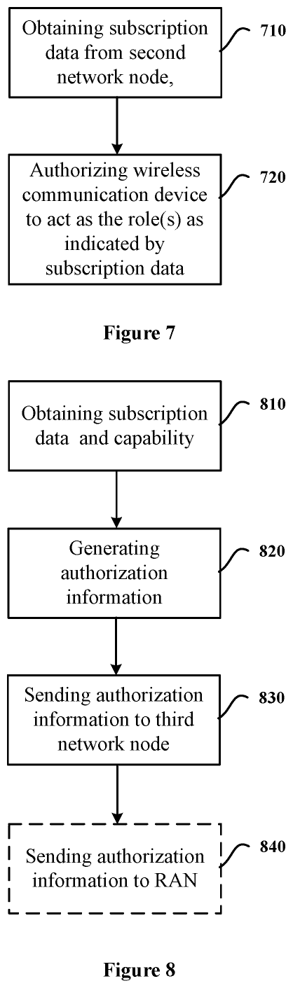

FIG. 7 is a flowchart illustrating a method for providing relay functionality implemented in a wireless communication network, in accordance with another embodiment. The wireless communication network may include a Radio Access Network (RAN) and a Core Network (CN) including a plurality of network nodes, e.g., AMF node, UDM node, PCF node, NEF node, NRF node, SMF node, AUSP node and AF node.

At step 710, a first network node obtains subscription data associated with a UE from a second network node. In this embodiment, the subscription data configured to indicate which role(s) the UE is authorized or allowed to act or operate as in U2N relay and/or U2U relay.

Optionally, the subscription data may be configured to specify at least one of the following items:
whether the UE is authorized to act as a remote UE for Layer-2 U2N relay;
whether the UE is authorized to act as a relay UE for Layer-2 U2N relay;
whether the UE is authorized to act as a remote UE for Layer-3 U2N relay;
whether the UE is authorized to act as a relay UE for Layer-3 U2N relay;
whether the UE is authorized to act as a remote UE for Layer-2 U2U relay;
whether the UE is authorized to act as a relay UE for Layer-2 U2U relay;
whether the UE is authorized to act as a remote UE for Layer-3 U2U relay; and
whether the UE is authorized to act as a relay UE for Layer-3 U2U relay.

Optionally, the first network node is an Access and Mobility Management Function (AMF) node, and the second network node is a Unified Data Management (UDM) node.

At step 720, the first network node authorize the UE to act as the role(s) as indicated by the subscription data. For example, if the subscription data indicate that the UE is authorized to act as a remote UE for Layer-2 and Layer 3 U2N relay, the first network node will authorize the UE to only act as a remote UE in Layer-2 U2N relay and Layer-3 U2N relay. In other words, the other roles, e.g., remote UE for Layer-2 U2U relay, Layer-3 U2U relay, and relay UE for Layer-2 U2N relay, Layer-3 U2N relay, Layer-2 U2U relay and Layer-3 U2U relay, are unallowable for the UE.

FIG. 8 is a flowchart illustrating a method for providing relay functionality implemented in a wireless communication network, in accordance with another embodiment. The wireless communication network may include a Radio Access Network (RAN) and a Core Network (CN) including a plurality of network nodes, e.g., AMF node, UDM node, PCF node, NEF node, NRF node, SMF node, AUSP node and AF node.

At step 810, a first network node obtains subscription data associated with a UE from a second network node and capability for U2N relay and/or U2U relay of the UE.

Optionally, the subscription data may be configured to specify at least one of the following items:
whether the UE is authorized to act as a remote UE for Layer-2 U2N relay;
whether the UE is authorized to act as a relay UE for Layer-2 U2N relay;
whether the UE is authorized to act as a remote UE for Layer-3 U2N relay;
whether the UE is authorized to act as a relay UE for Layer-3 U2N relay;
whether the UE is authorized to act as a remote UE for Layer-2 U2U relay;
whether the UE is authorized to act as a relay UE for Layer-2 U2U relay;
whether the UE is authorized to act as a remote UE for Layer-3 U2U relay; and
whether the UE is authorized to act as a relay UE for Layer-3 U2U relay.

At step 820, the first network node may generate authorization information based on the subscription data and the capability. In this embodiment, the authorization information is configured to specify which role(s) the UE is authorized or allowed to act or operate as in U2N relay and/or U2U relay.

Optionally, the authorization information may be configured to specify at least one of the following items:
whether the UE is authorized to act as a remote UE for Layer-2 U2N relay;
whether the UE is authorized to act as a relay UE for Layer-2 U2N relay;
whether the UE is authorized to act as a remote UE for Layer-3 U2N relay;
whether the UE is authorized to act as a relay UE for Layer-3 U2N relay;
whether the UE is authorized to act as a remote UE for Layer-2 U2U relay;
whether the UE is authorized to act as a relay UE for Layer-2 U2U relay;
whether the UE is authorized to act as a remote UE for Layer-3 U2U relay; and
whether the UE is authorized to act as a relay UE for Layer-3 U2U relay.

For example, it assumes that the subscription data indicate that the UE is authorized to act as a remote UE for Layer-2 and Layer 3 U2N relay and the UE is capable of acting as a replay UE for Layer-2 and Layer 3 U2N relay. For this situation, although the UE is capable of acting as a replay UE, the first network node will authorize the UE to only act as a remote UE in Layer-2 U2N relay and Layer-3 U2N relay.

At step 830, the first network node sends the authorization information to a third network node.

Optionally, at step 840, the first network node sends the authorization information to the RAN of the wireless communication network.

Optionally, the first network node is an Access and Mobility Management Function (AMF) node, the second network node is a Unified Data Management (UDM) node, and the third network node is a Policy Control Function (PCF) node.

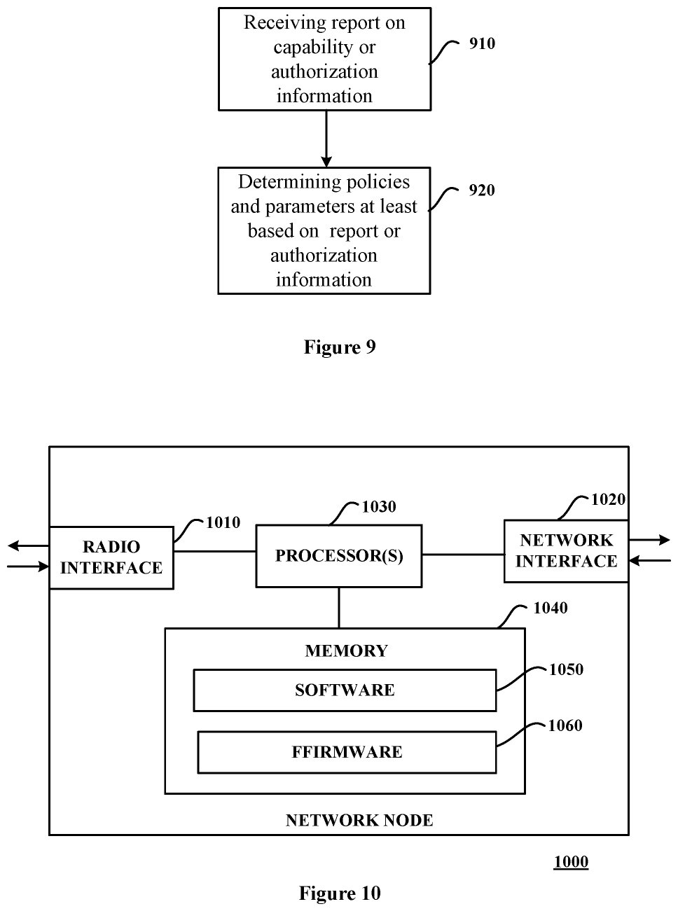

FIG. 9 is a flowchart illustrating a method for providing relay functionality implemented in a wireless communication network, in accordance with another embodiment. The wireless communication network may include a Radio Access Network (RAN) and a Core Network (CN) including a plurality of network nodes, e.g., AMF node, UDM node, PCF node, NEF node, NRF node, SMF node, AUSP node and AF node.

At step 910, a first network node receives, from a second network node, at least one of the following items:
a report on capability for UE-to-Network (U2N) relay and/or UE-to-UE (U2U) relay of a UE,
authorization information specifying which role(s) the UE is allowed to act as in U2N relay and/or U2U relay.

Optionally, the first network node is a Policy Control Function (PCF) node, and the second network node is an Access and Mobility Management Function (AMF) node.

Optionally, the report may indicate at least one of the following items:
whether the UE is capable of acting as a remote UE for Layer-2 U2N relay;
whether the UE is capable of acting as a relay UE for Layer-2 U2N relay;
whether the UE is capable of acting as a remote UE for Layer-3 U2N relay;
whether the UE is capable of acting as a relay UE for Layer-3 U2N relay;
whether the UE is capable of acting as a remote UE for Layer-2 U2U relay;
whether the UE is capable of acting as a relay UE for Layer-2 U2U relay;
whether the UE is capable of acting as a remote UE for Layer-3 U2U relay; and
whether the UE is capable of acting as a relay UE for Layer-3 U2U relay.

Optionally, the authorization information may be configured to specify at least one of the following items:
whether the UE is authorized to act as a remote UE for Layer-2 U2N relay;
whether the UE is authorized to act as a relay UE for Layer-2 U2N relay;
whether the UE is authorized to act as a remote UE for Layer-3 U2N relay;
whether the UE is authorized to act as a relay UE for Layer-3 U2N relay;
whether the UE is authorized to act as a remote UE for Layer-2 U2U relay;
whether the UE is authorized to act as a relay UE for Layer-2 U2U relay;
whether the UE is authorized to act as a remote UE for Layer-3 U2U relay; and
whether the UE is authorized to act as a relay UE for Layer-3 U2U relay.

At step 920, the first network node determines policies and parameters at least based on the report or the authorization information. Optionally, the determining is made based on either the combination of the report and local policies, or the combination of the authorization information and the local policies.

Optionally, if the UE is authorized to act or capable of acting as a remote UE for Layer-2 U2N relay and Layer-3 U2N relay, the policies and parameters may be configured to specify which relay type is preferred for all or specific ProSe services. In other words, the policies and parameters may specify Layer-2 U2N relay or Layer-3 U2N relay as the preferred relay type.

Optionally, if the UE is authorized to act or capable of acting as a remote UE for Layer-2 U2U relay and Layer-3 U2U relay, the policies and parameters may be configured to specify which relay type is preferred for all or specific ProSe services. In other words, the policies and parameters may specify Layer-2 U2U relay or Layer-3 U2U relay as the preferred relay type.

Optionally, if the UE is authorized to act or capable of acting as a remote UE for Layer-3 U2N relay, the policies and parameters may be configured to specify whether the UE when acting as the remote UE needs to access N3IWF for all or specific ProSe service.

Optionally, the policies and parameters may include UE Route Selection Policy (URSP) rules specifying relay type selection for the UE.

For U2N relay, an indication of Layer-2 U2N relay and an indication of Layer-3 U2N relay are included in a Route Selection Descriptor to specify the relay type selection. Alternatively, an indication of Layer-2 U2N relay and an indication of Layer-3 U2N relay are included in an Access Type preference to specify the relay type selection if U2N relay is not considered as 3GPP access or Non-3GPP access. Alternatively, a separate indication of N3IWF is included in a Route Selection Descriptor to indicate whether the UE acting as a remote UE should connect to the N3IWF for specific service traffic.

For U2U relay, an indication of Layer-2 U2U relay and an indication of Layer-3 U2U relay may be included in a Route Selection Descriptor to specify the relay type selection. Alternatively, an indication of PC5 or sidelink may be included in an Access Type preference to indicate that traffic is transferred via a PC5 interface or sidelink.

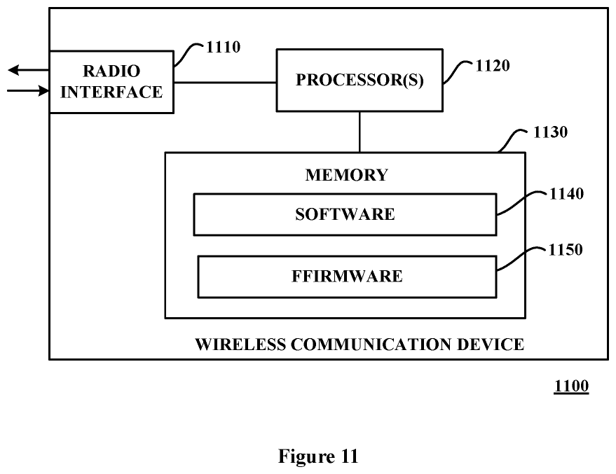

FIG. 10 illustrates a processor-based implementation of a network node which may be used for implementing the above-described embodiments. For example, the structures as illustrated in FIG. 10 may be used for implementing the concepts in any of the above-mentioned access nodes.

As illustrated, the node 1000 may include one or more radio interfaces 1010. The radio interface(s) 1010 may for example be based on the NR technology or the LTE technology. The radio interface(s) 1010 may be used for controlling wireless communication devices, such as any of the above-mentioned UEs. In addition, the node 1000 may include one or more network interfaces 1020. The network interface(s) 1020 may for example be used for communication with one or more other nodes of the wireless communication network.

Further, the node 1000 may include one or more processors 1030 coupled to the interfaces 1010, 1020 and a memory 1040 coupled to the processor(s) 1030. By way of example, the interfaces 1010, 1020, the processor(s) 1030, and the memory 1040 could be coupled by one or more internal bus systems of the node 1000. The memory 1040 may include a Read-Only-Memory (ROM), e.g., a flash ROM, a Random Access Memory (RAM), e.g., a Dynamic RAM (DRAM) or Static RAM (SRAM), a mass storage, e.g., a hard disk or solid state disk, or the like. As illustrated, the memory 1040 may include software 1050 and/or firmware 1060. The memory 1040 may include suitably configured program code to be executed by the processor(s) 1030 so as to implement the above-described functionalities for time synchronization, such as explained in connection with FIGS. 6 to 9.

It is to be understood that the structure as illustrated in FIG. 10 is merely schematic and that the node 1000 may actually include further components which, for the sake of clarity, have not been illustrated, e.g., further interfaces, such as a dedicated management interface, or further processors. Also, it is to be understood that the memory 1040 may include further program code for implementing known functionalities of an AMF node or a PCF node.

According to some embodiments, also a computer program may be provided for implementing functionalities of the node 1000, e.g., in the form of a physical medium storing the program code and/or other data to be stored in the memory 1040 or by making the program code available for download or by streaming.

FIG. 11 illustrates a processor-based implementation of a wireless communication device which may be used for implementing the above-described embodiments.

As illustrated, the wireless communication device 1100 includes one or more radio interfaces 1110. The radio interface(s) 1110 may for example be based on the NR technology or the LTE technology.

Further, the wireless communication device 1100 may include one or more processors 1120 coupled to the radio interface(s) 1110 and a memory 1130 coupled to the processor(s) 1120.

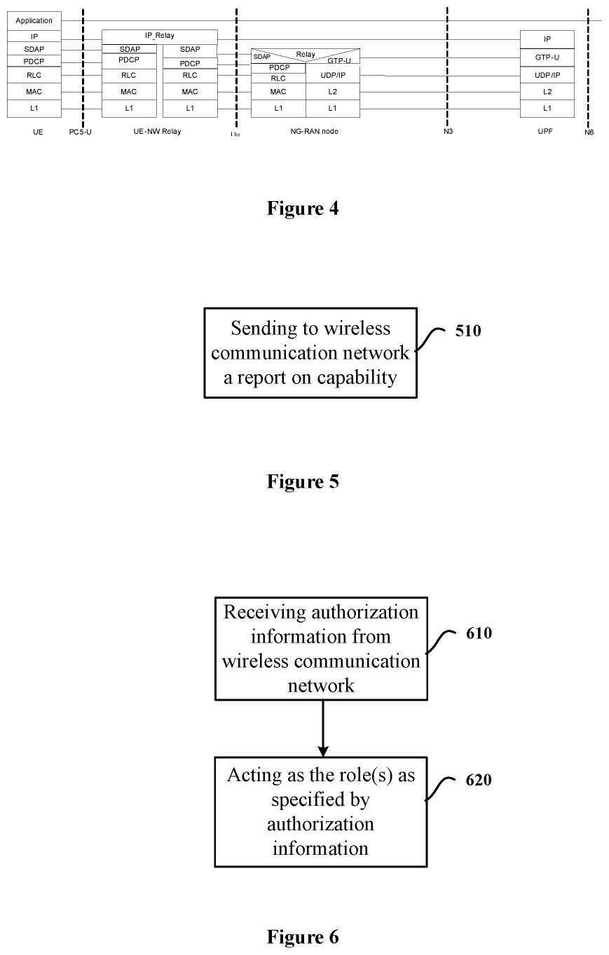

By way of example, the radio interface(s) 1110, the processor(s) 1120, and the memory 1130 could be coupled by one or more internal bus systems of the wireless communication device 1100. The memory 1130 may include a Read-Only-Memory (ROM), e.g., a flash ROM, a Random Access Memory (RAM), e.g., a Dynamic RAM (DRAM) or Static RAM (SRAM), a mass storage, e.g., a hard disk or solid state disk, or the like. As illustrated, the memory 1130 may include software 1140 and/or firmware 1150. The memory 1130 may include suitably configured program code to be executed by the processor(s) 1120 so as to implement the above-described functionalities for time synchronization, such as explained in connection with FIGS. 4 and 5.

It is to be understood that the structure as illustrated in FIG. 11 is merely schematic and that the wireless communication device 1100 may actually include further components which, for the sake of clarity, have not been illustrated, e.g., further interfaces, such as a dedicated management interface, or further processors. Also, it is to be understood that the memory 1130 may include further program code for implementing known functionalities of a UE.

According to some embodiments, also a computer program may be provided for implementing functionalities of the wireless communication device 1100, e.g., in the form of a physical medium storing the program code and/or other data to be stored in the memory 1130 or by making the program code available for download or by streaming.

### Embodiment 1

In the first embodiment, a UE provides it PC5 capability for UE-to-Network (U2N) relaying during its registration phase. The PC5 capability for UE-to-Network relaying include:
whether the UE is capable of acting as a remote UE for Layer-2 U2N relaying
whether the UE is capable of acting as a relay UE for Layer-2 U2N relaying
whether the UE is capable of acting as a remote UE for Layer-3 U2N relaying
whether the UE is capable of acting as relay UE for Layer-3 U2N relaying

### Embodiment 2

In the second embodiment, an AMF node authorizes the UE to act as the role(s) as indicated by the subscription data based on its subscription data from a UDM node, wherein the subscription data are configured to indicate:
If the UE is authorized to authorized to act as a remote UE for Layer-2 U2N relaying
If the UE is authorized to authorized to act as a relay UE for Layer-2 U2N relaying
If the UE is authorized to authorized to act as a remote UE for Layer-3 U2N relaying
If the UE is authorized to authorized to act as a relay UE for Layer-3 U2N relaying

### Embodiment 3

In the third embodiment, depending on relay capability of a UE and subscription data for the UE, an AMF node informs a PCF node of the UE's authorization information or authorized ProSe capabilities. The AMF node may include the following information in the Npcf_UEPolicyControl_Create Service as part of the input parameters as defined in clause 4.2.2. in 3GPP TS 29.525:

UE is capable of acting as a remote/relay UE for Layer-2 or Layer-3 relaying or both.

### Embodiment 4

In the fourth embodiment, a PCF node provides policies and parameters according to the UE's capabilities from an AMF node as well as local policies, e.g. the operator only allows one type of relaying for the UE, the PCF only provides parameters for either L2 relaying or L3 relaying but not both.

### Embodiment 5

In the fifth embodiment, if policies and parameters of both L2 and L3 are provisioned to the UE, and if a UE can act as a remote UE, a PCF node may also provide selection preferences to indicate which type (Layer-2 or Layer-3) of relay is preferred for all or specific ProSe services. The ProSe services can be identified by the traffic descriptor as defined in 3GPP TS 23.503.

### Embodiment 6

In the sixth embodiment, if policies and parameters for L3 U2N relay are provided to the UE, a PCF node may also provide policies about if the remote UE needs to access N3IWF for all or specific ProSe service. The ProSe services can be identified by the traffic descriptor as defined in 3GPP TS 23.503.

### Embodiment 7

In the seventh embodiment, the features and aspects of the above embodiments 1 to 5 are applied to UE-to-UE (U2U) relay use case. That is, U2N relay is replaced by U2U relay.

### Embodiment 8

In the eighth embodiment, a PCF node may also provide URSP rules reflecting relay type selection for a UE.

Regarding U2N relay, in the Route Selection Descriptor as defined in 3GPP TS 23.503, an indication of Layer-2 U2N relay and an indication of Layer-3 U2N relaying could be included. In Access Type preference, an indication of Layer-2 U2N relay and an indication of Layer-3 U2N relay could be included if U2N relaying is not considered as 3GPP access or Non-3GPP access.

For example, for traffic of a specific service, at first, the UE may try to direct Uu interface according to the Access Type preference. If fails, then the UE may try Layer-2 U2N relay, and if still fails, then the UE may try Layer-3 U2N relay.

When using Layer-3 U2N relay to forward the traffic, the remote UE may also check other Route section components (e.g. SSC mode, DNN Selection, etc.). If the relay UE's PDU session does not meet the requirements, the remote UE may establish connection with N3IWF. Alternatively, a separate indication of N3IWF can be included in the Route Selection Descriptor to indicate if the remote UE should connect to N3IWF for the specific service traffic.

Regarding U2U relaying, in the Route Selection Descriptor as defined in 3GPP TS 23.503, an indication of Layer-2 U2U relay and an indication of Layer-3 U2U relay could be included. In Access Type preference, an indication of PC5 or Sidelink could be included to indicate that the traffic is transferred via PC5 interface or sidelink.

### Embodiment 9

In the ninth embodiment, an AMF node provides authorization information to NG-RAN. The authorization information may be configured to specify:
whether the UE is authorized or allowable to act as a remote UE for Layer-2 U2N/U2U relay
whether the UE is authorized or allowable to act as a relay UE for Layer-2 U2N/U2U relay
whether the UE is authorized or allowable to act as a remote UE for Layer-3 U2N/U2U relay
whether the UE is authorized or allowable to act as a relay UE for Layer-3 U2N/U2U relay

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the scope of the disclosure as those skilled in the art readily understand. Such modifications and variations are considered to be within the scope of the disclosure and the appended claims. The protection scope of the disclosure is defined by the accompanying claims.

1.-51. (canceled)

52. A method for providing relay functionality in a wireless communication network, comprising the following steps carried out at a wireless communication device:
during a registration procedure, sending, to the wireless communication network, a report on capability for UE-to-Network (U2N) relay and/or UE-to-UE (U2U) relay of the wireless communication device;
receiving, from the wireless communication network, authorization information specifying which role(s) the wireless communication device is authorized to act as in U2N relay and/or U2U relay; and
acting as the role(s) as specified by the authorization information when performing discovery and/or a communication,
wherein at least one of the following items is indicated by the report or specified by the authorization information:
whether the wireless communication device is capable of acting as a remote UE for Layer-2 U2N relay;
whether the wireless communication device is capable of acting as a relay UE for Layer-2 U2N relay;
whether the wireless communication device is capable of acting as a remote UE for Layer-3 U2N relay;
whether the wireless communication device is capable of acting as a relay UE for Layer-3 U2N relay,
wherein the authorization information is generated based on subscription data associated with the wireless communication device or the capability, whichever is available.

53. The method according to claim 52, wherein at least one of the following additional items is indicated by the report or specified by the authorization information:
whether the wireless communication device is capable of acting as a remote UE for Layer-2 U2U relay;
whether the wireless communication device is capable of acting as a relay UE for Layer-2 U2U relay;
whether the wireless communication device is capable of acting as a remote UE for Layer-3 U2U relay; and
whether the wireless communication device is capable of acting as a relay UE for Layer-3 U2U relay.

54. A wireless communication device, comprising:
at least one processor; and
a memory containing program code executable by the at least one processor,
whereby execution of the program code by the at least one processor causes the wireless communication device to:
during a registration procedure, send, to the wireless communication network, a report on capability for UE-to-Network (U2N) relay and/or UE-to-UE (U2U) relay of the wireless communication device;
receive, from the wireless communication network, authorization information specifying which role(s) the wireless communication device is authorized to act as in U2N relay and/or U2U relay; and
act as the role(s) as specified by the authorization information when performing discovery and/or a communication,
wherein at least one of the following items is indicated by the report or specified by the authorization information:
whether the wireless communication device is capable of acting as a remote UE for Layer-2 U2N relay;
whether the wireless communication device is capable of acting as a relay UE for Layer-2 U2N relay;
whether the wireless communication device is capable of acting as a remote UE for Layer-3 U2N relay;
whether the wireless communication device is capable of acting as a relay UE for Layer-3 U2N relay,
wherein the authorization information is generated based on subscription data associated with the wireless communication device or the capability, whichever is available.

55. The wireless communication device according to claim 54, wherein at least one of the following additional items is indicated by the report or specified by the authorization information:
whether the wireless communication device is capable of acting as a remote UE for Layer-2 U2U relay;
whether the wireless communication device is capable of acting as a relay UE for Layer-2 U2U relay;
whether the wireless communication device is capable of acting as a remote UE for Layer-3 U2U relay; and
whether the wireless communication device is capable of acting as a relay UE for Layer-3 U2U relay.

56. The wireless communication device according to claim 54, wherein the wireless communication device is selected from a group comprising UE, Tablet, mobile terminals, smart phone, laptop embedded equipped, laptop mounted equipment, and Internet of Things (IoT) device.

57. A method for providing relay functionality in a wireless communication network, comprising the following steps carried out at a first network node:
obtaining, from a second network node, subscription data associated with a wireless communication device, the subscription data configured to indicate which role(s) the wireless communication device is allowed to act as in U2N relay and/or U2U relay; and
authorizing the wireless communication device to act as the role(s) as indicated by the subscription data,
wherein the subscription data indicates at least one of the following items:
whether the wireless communication device is authorized to act as a remote UE for Layer-2 U2N relay;
whether the wireless communication device is authorized to act as a relay UE for Layer-2 U2N relay;
whether the wireless communication device is authorized to act as a remote UE for Layer-3 U2N relay;
whether the wireless communication device is authorized to act as a relay UE for Layer-3 U2N relay.

58. The method according to claim 57, wherein the subscription data further indicates at least one of the following items:
whether the wireless communication device is authorized to act as a remote UE for Layer-2 U2U relay;
whether the wireless communication device is authorized to act as a relay UE for Layer-2 U2U relay;
whether the wireless communication device is authorized to act as a remote UE for Layer-3 U2U relay; and
whether the wireless communication device is authorized to act as a relay UE for Layer-3 U2U relay.

59. The method according to claim 57, wherein the first network node is an Access and Mobility Management Function (AMF) node, and the second network node is a Unified Data Management (UDM) node.

60. A method for providing relay functionality in a wireless communication network, comprising the following steps carried out at a first network node:
obtaining subscription data associated with a wireless communication device from a second network node and capability for U2N relay and/or U2U relay of the wireless communication device;
based on the subscription data and the capability, generating (820) authorization information specifying which role(s) the wireless communication device is authorized to act as in U2N relay and/or U2U relay; and
sending the authorization information to a third network node,
wherein the authorization information specifies at least one of the following items:
whether the wireless communication device is authorized to act as a remote UE for Layer-2 U2N relay;
whether the wireless communication device is authorized to act as a relay UE for Layer-2 U2N relay;
whether the wireless communication device is authorized to act as a remote UE for Layer-3 U2N relay;
whether the wireless communication device is authorized to act as a relay UE for Layer-3 U2N relay.

61. The method according to claim 60, wherein the authorization information further specifies at least one of the following items:
whether the wireless communication device is authorized to act as a remote UE for Layer-2 U2U relay;
whether the wireless communication device is authorized to act as a relay UE for Layer-2 U2U relay;
whether the wireless communication device is authorized to act as a remote UE for Layer-3 U2U relay; and
whether the wireless communication device is authorized to act as a relay UE for Layer-3 U2U relay.

62. The method according to claim 60, further comprising:
sending the authorization information to a Radio Access network (RAN).

63. The method according to claim 60, wherein the first network node is an Access and Mobility Management Function (AMF) node, the second network node is a Unified Data Management (UDM) node, and the third network node is a Policy Control Function (PCF) node.

64. A first network node for providing relay functionality in a wireless communication network, comprising:
at least one processor; and
a memory containing program code executable by the at least one processor,
whereby execution of the program code by the at least one processor causes the first network node to:
obtain, from a second network node, subscription data associated with a wireless communication device, the subscription data configured to indicate which role(s) the wireless communication device is authorized to act as in U2N relay and/or U2U relay; and
authorize the wireless communication device to act as the role(s) as indicated by the subscription data,
wherein the subscription data indicates at least one of the following items:
whether the wireless communication device is authorized to act as a remote UE for Layer-2 U2N relay;
whether the wireless communication device is authorized to act as a relay UE for Layer-2 U2N relay;
whether the wireless communication device is authorized to act as a remote UE for Layer-3 U2N relay;
whether the wireless communication device is authorized to act as a relay UE for Layer-3 U2N relay.

65. The first network node according to claim 64, wherein the subscription data further indicates at least one of the following items:
whether the wireless communication device is authorized to act as a remote UE for Layer-2 U2U relay;
whether the wireless communication device is authorized to act as a relay UE for Layer-2 U2U relay;
whether the wireless communication device is authorized to act as a remote UE for Layer-3 U2U relay; and
whether the wireless communication device is authorized to act as a relay UE for Layer-3 U2U relay.

66. The first network node according to claim 64 wherein the first network node is an Access and Mobility Management Function (AMF) node, and the second network node is a Unified Data Management (UDM) node.

67. A first network node for providing relay functionality in a wireless communication network, comprising:
at least one processor; and
a memory containing program code executable by the at least one processor,
whereby execution of the program code by the at least one processor causes the first network node to:
obtain subscription data associated with a wireless communication device from a second network node and capability for U2N relay and/or U2U relay of the wireless communication device;
based on the subscription data and the capability, generate authorization information specifying which role(s) the wireless communication device is authorized to act as in U2N relay and/or U2U relay; and
send the authorization information to a third network node,
wherein the authorization information specifies at least one of the following items:
whether the wireless communication device is authorized to act as a remote UE for Layer-2 U2N relay;
whether the wireless communication device is authorized to act as a relay UE for Layer-2 U2N relay;
whether the wireless communication device is authorized to act as a remote UE for Layer-3 U2N relay;
whether the wireless communication device is authorized to act as a relay UE for Layer-3 U2N relay.

68. The first network node according to claim 67, wherein the authorization information further specifies at least one of the following items:
whether the wireless communication device is authorized to act as a remote UE for Layer-2 U2U relay;
whether the wireless communication device is authorized to act as a relay UE for Layer-2 U2U relay;
whether the wireless communication device is authorized to act as a remote UE for Layer-3 U2U relay; and
whether the wireless communication device is authorized to act as a relay UE for Layer-3 U2U relay.

69. The first network node according to claim 67, wherein the execution of the program code by the at least one processor further causes the first network node to:
send the authorization information to a Radio Access network (RAN).

70. The first network node according to claim 67, wherein the first network node is an Access and Mobility Management Function (AMF) node, the second network node is a Unified Data Management (UDM) node, and the third network node is a Policy Control Function (PCF) node.

71. A method for providing relay functionality in a wireless communication network, comprising the following steps carried out at a first network node:
receiving, from a second network node, a report on capability for UE-to-Network (U2N) relay and/or UE-to-UE (U2U) relay of a wireless communication device, and authorization information specifying which role(s) the wireless communication device is authorized to act as in U2N relay and/or U2U relay; and
determining policies and parameters at least based on the capability and the authorization information,
wherein the authorization information is generated at least based on subscription data associated with the wireless communication device.

72. The method according to claim 71, wherein the report indicates at least one of the following items:
whether the wireless communication device is capable of acting as a remote UE for Layer-2 U2N relay;
whether the wireless communication device is capable of acting as a relay UE for Layer-2 U2N relay;
whether the wireless communication device is capable of acting as a remote UE for Layer-3 U2N relay;
whether the wireless communication device is capable of acting as a relay UE for Layer-3 U2N relay;
whether the wireless communication device is capable of acting as a remote UE for Layer-2 U2U relay;
whether the wireless communication device is capable of acting as a relay UE for Layer-2 U2U relay;
whether the wireless communication device is capable of acting as a remote UE for Layer-3 U2U relay; and
whether the wireless communication device is capable of acting as a relay UE for Layer-3 U2U relay,
wherein the authorization information specifies at least one of the following items:
whether the wireless communication device is authorized to act as a remote UE for Layer-2 U2N relay;
whether the wireless communication device is authorized to act as a relay UE for Layer-2 U2N relay;
whether the wireless communication device is authorized to act as a remote UE for Layer-3 U2N relay;
whether the wireless communication device is authorized to act as a relay UE for Layer-3 U2N relay;
whether the wireless communication device is authorized to act as a remote UE for Layer-2 U2U relay;
whether the wireless communication device is authorized to act as a relay UE for Layer-2 U2U relay;
whether the wireless communication device is authorized to act as a remote UE for Layer-3 U2U relay; and
whether the wireless communication device is authorized to act as a relay UE for Layer-3 U2U relay.

73. The method according to claim 71, wherein the wireless communication device is authorized to act or capable of acting as a remote UE for Layer-2 U2N relay and Layer-3 U2N relay, and the policies and parameters specify which relay type is preferred for all or specific ProSe services.

74. The method according to claim 71, wherein the wireless communication device is authorized to act or capable of acting as a remote UE for Layer-2 U2U relay and Layer-3 U2U relay, and the policies and parameters specify which relay type is preferred for all or specific ProSe services.

75. The method according to claim 71, wherein the wireless communication device is authorized to act or capable of acting as a remote UE for Layer-3 U2N relay, and the policies and parameters specify whether the wireless communication device acting as the remote UE needs to access N3IWF for all or specific ProSe service.

76. The method according to claim 71, wherein the policies and parameters include UE Route Selection Policy (URSP) rules specifying relay type selection for the wireless communication device.

77. The method according to claim 73, wherein an indication of PC5 or sidelink is included in an Access Type preference to indicate that traffic is transferred via a PC5 interface or sidelink.
